(19) United States
(12) Patent Application Publication
(10) Pub. No.: US 2025/0219117 A1
(43) Pub. Date: Jul. 3, 2025

(54) FUEL CELL SYSTEM

(71) Applicant: AISAN KOGYO KABUSHIKI KAISHA, Obu-shi, Aichi (JP)

(72) Inventors: Kazunori ITO, Nagoya-shi (JP); Masafumi YAMAGATA, Toyoake-shi (JP)

(73) Assignee: AISAN KOGYO KABUSHIKI KAISHA, Obu-shi, Aichi (JP)

(21) Appl. No.: 18/847,356

(22) PCT Filed: Mar. 7, 2023
(86) PCT No.: PCT/JP2023/008586

§ 371 Date: Sep. 16, 2024

(30) Foreign Application Priority Data
Apr. 15, 2022 (JP) 2022-067358

(51) Int. Cl. H01M 8/04746; H01M 8/04082; H01M 8/04089; H01M 8/0438

(52) U.S. Cl. CPC H01M 8/04776; H01M 8/04097; H01M 8/04201; H01M 8/0438; H01M 8/04753; H01M 8/04761

(57) ABSTRACT

A fuel cell system includes a fuel cell, a fuel supply passage for supplying fuel to the fuel cell, an ejector provided to the fuel supply passage, and a circulation passage for circulating, to the ejector, the unused fuel discharged from the fuel cell, the fuel cell system supplying the fuel to the fuel cell through the fuel supply passage via the ejector. The fuel cell system includes: a bypass passage for supplying the fuel to the fuel cell without passing through the ejector; and a bypass flow regulating unit for regulating the flow rate of the fuel in the bypass passage.

### TECHNICAL FIELD

The disclosure relates to a fuel cell system.

### BACKGROUND ART

Patent document 1 discloses a fuel cell system including an ejector for circulating off-gas, which is unused fuel discharged from a fuel cell, into a fuel supply passage. In the ejector, a small nozzle with a small diameter and a large nozzle with a large diameter are coaxially placed as a plurality of nozzles for injecting fuel at different flow rates.

### RELATED ART DOCUMENTS

### Patent Documents

Patent Document 1: Japanese patent No. 3608541

### SUMMARY OF INVENTION

### Problems to be Solved by the Invention

In the ejector of the fuel cell system disclosed in Patent document 1, when the nozzle used is switched from the small nozzle to the large nozzle, the flow velocity of fuel supplied to the ejector decreases, and the negative pressure for sucking off-gas discharged from the fuel cell may be significantly decreased. In this case, the flow rate of off-gas circulated, or returned, to the ejector decreases, resulting in a reduced flow rate of fuel to be supplied to the fuel cell via the ejector, and a required flow rate of fuel may not be supplied to the fuel cell.

The present disclosure has been made to address the above problems and has a purpose to provide a fuel cell system capable of stably supplying a required flow rate of fuel to a fuel cell.

### Means of Solving the Problems

To achieve the above-mentioned purpose, one aspect of the disclosure provides a fuel cell system including: a fuel cell; a fuel supply passage for supplying fuel to the fuel cell; an ejector provided in the fuel supply passage; and a circulation passage for circulating the fuel that is unused in and discharged from the fuel cell to the ejector, the fuel cell system being configured to supply the fuel to the fuel cell through the fuel supply passage via the ejector, wherein the fuel cell system comprises: a bypass passage for supplying the fuel to the fuel cell without passing through the ejector; and a bypass flow regulating unit for regulating a flow rate of the fuel in the bypass passage.

According to the above aspect, when a flow rate of the fuel to be supplied to the fuel cell through the fuel supply passage by passing through the ejector is less than required, it is possible to stably supply a required flow rate of fuel to the fuel cell by supplying the fuel to the fuel cell through the bypass passage without passing through the ejector. This can improve the controllability of the fuel cell.

In the above-described aspect, preferably, the ejector includes, as a nozzle for injecting the fuel, a first nozzle; and a second nozzle that can inject the fuel with a larger flow rate than the first nozzle, wherein in a first supply region until a required supply flow rate of the fuel for the fuel cell reaches or nearly reaches a first flow rate that is a maximum flow rate during use of the first nozzle, the fuel is supplied to the fuel cell using the first nozzle, in a second supply region from when the required supply flow rate of the fuel for the fuel cell exceeds the first supply region until the required supply flow rate reaches or nearly reaches a second flow rate, which is a maximum flow rate at which a circulation efficiency of the ejector becomes a maximum value during use of the second nozzle, the fuel is supplied to the fuel cell using the first nozzle and also the fuel is supplied to the fuel cell through the bypass passage, and in a third supply region where the required supply flow rate of the fuel for the fuel cell exceeds the second supply region, the fuel is supplied to the fuel cell using the second nozzle.

According to this aspect, while the fuel is being supplied to the fuel cell using the first nozzle, in the second supply region from when the required supply flow rate of fuel for the fuel cell exceeds the first supply region until the required supply flow rate of fuel for the fuel cell reaches or nearly reaches the second flow rate, the fuel is supplied to the fuel cell through the bypass passage while fuel supply to the fuel cell using the first nozzle is continued. In this way, the first nozzle that allows for a higher circulation efficiency of the ejector than the second nozzle is continuously used.

As a result, the circulation efficiency of the ejector can be improved as compared with the configuration that supplies the fuel to a fuel cell using the second nozzle by switching from the first nozzle to the second nozzle immediately when the required supply flow rate of the fuel for the fuel cell exceeds the first nozzle region. Therefore, the fuel is supplied to the fuel cell through the fuel supply passage via the ejector while ensuring a circulation flow rate of unused fuel to the ejector and also the fuel is supplied to the fuel cell through the bypass passage. This can stably supply a required flow rate of fuel to the fuel cell more reliably.

Further, the first nozzle is used in the first supply region, the first nozzle and the bypass passage are used in the second supply region, and the second nozzle is used in the third supply region. This configuration can stably supply a required flow rate of fuel to the fuel cell in all the regions of required supply flow rates of fuel for the fuel cell.

Another aspect of the disclosure to solve the aforementioned problem provides a fuel cell system including: a fuel cell; a fuel supply passage for supplying fuel to the fuel cell; an ejector provided in the fuel supply passage; and a circulation passage for circulating the fuel that is unused in and discharged from the fuel cell to the ejector, the fuel cell system being configured to supply the fuel to the fuel cell through the fuel supply passage via the ejector, wherein the ejector includes, as a nozzle for injecting the fuel, a first nozzle; and a second nozzle that can inject the fuel with a larger flow rate than the first nozzle, and when switching the nozzle used from the first nozzle to the second nozzle, both the first and second nozzles are used for a predetermined time.

This aspect can compensate for a shortage of fuel flow at the initial stage when the first nozzle is switched to the second nozzle as the nozzle used in the ejector, and thus the circulation efficiency of the ejector can be improved.

### Effects of the Invention

The fuel cell system of the disclosure can supply a required flow rate of fuel to a fuel cell.

### BRIEF DESCRIPTION OF THE DRAWINGS

FIG. 1 is a structure diagram of a fuel cell system in first and second embodiments;

FIG. 2 is a structure diagram of an ejector in the first and second embodiments;

FIG. 3 is a graph showing a relationship between a required supply flow rate and a circulation efficiency of an ejector in the first embodiment;

FIG. 4 is a flowchart showing details of a control executed in the first embodiment;

FIG. 5 is a time chart showing one example of the control executed in the first embodiment;

FIG. 6 is a flowchart showing details of a control executed in the second embodiment;

FIG. 7 is a flowchart showing details of an overlap control;

FIG. 8 is a time chart showing one example of the control executed in the second embodiment; and

FIG. 9 is a graph showing a relationship between a required supply flow rate and a circulation efficiency of an ejector in a related art.

### MODE FOR CARRYING OUT THE INVENTION

An embodiment of a fuel cell system of the disclosure will be described below.

### First Embodiment

A first embodiment will be described first.

### <Overview of Fuel Cell System>

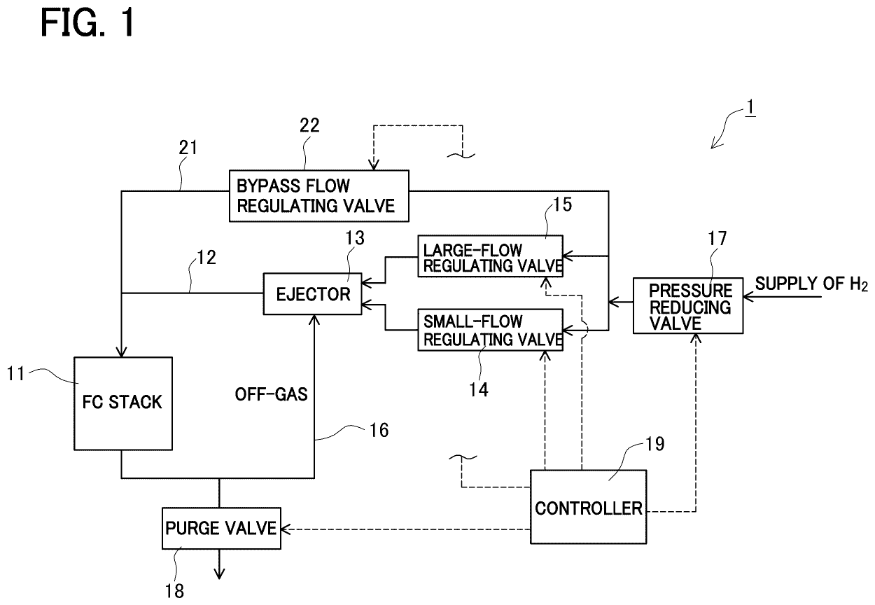

A fuel cell system 1 in the present embodiment includes, as shown in FIG. 1, an FC stack 11, a fuel supply passage 12, an ejector 13, a small-flow regulating valve 14, a large-flow regulating valve 15, a circulation passage 16, a pressure reducing valve 17, a purge valve 18, a controller 19, and others.

The FC stack 11 is a fuel cell that generates power using hydrogen as fuel. The fuel supply passage 12 is a passage through which the fuel (e.g., hydrogen (H₂)) is supplied to the FC stack 11.

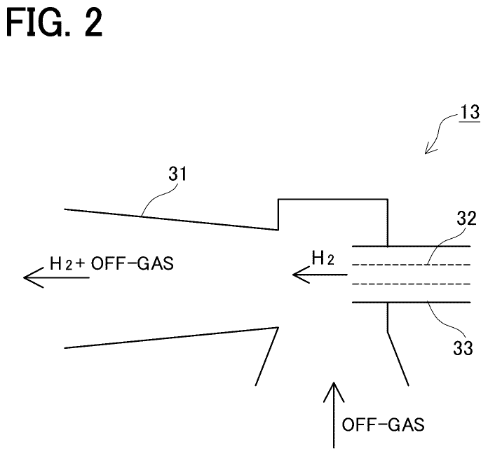

The ejector 13 is provided in the fuel supply passage 12. This ejector 13 is provided with a diffuser 31, and a small nozzle 32 and a large nozzle 33 for injecting fuel, as shown in FIG. 2. The small nozzle 32 has a smaller diameter than the large nozzle 33 and can inject a smaller flow rate of fuel than the large nozzle 33. The large nozzle 33 has a larger diameter than the small nozzle 32 and can inject a larger flow rate of fuel than the small nozzle 32. The small nozzle 32 and the large nozzle 33 are arranged coaxially, i.e., respective central axes coincide with each other, so that the small nozzle 32 is placed inside the large nozzle 33. The small nozzle 32 is one example of a “first nozzle” of the disclosure and the large nozzle 33 is one example of a “second nozzle” of the disclosure.

The ejector 13 configured as above injects fuel through the small nozzle 32 and/or the large nozzle 33 to supply the fuel into the diffuser 31 and also sucks off-gas (that is, unused fuel) through the circulation passage 16 by the negative pressure generated in the diffuser 31. Then, the fuel supplied into the diffuser 31 and the off-gas sucked through the circulation passage 16 are supplied together from the ejector 13 to the FC stack 11 through the fuel supply passage 12.

Returning to the description of FIG. 1, the small-flow regulating valve 14 regulates a flow rate of fuel to be supplied to the small nozzle 32, and the large-flow regulating valve 15 regulates a flow rate of fuel to be supplied to the large nozzle 33.

The circulation passage 16 is a passage for circulating the off-gas discharged from the FC stack 11 to the ejector 13.

The pressure reducing valve 17 is a valve for reducing the pressure of a high-pressure fuel supplied from a fuel tank (not shown). The purge valve 18 is a valve that is connected to the circulation passage 16 and will be opened to discharge out excess fuel that could not be consumed in the FC stack 11, that is, excess off-gas.

The controller 19 is an ECU that is provided with for example a central processing unit (CPU), various memories, and others, and controls the entire fuel cell system 1. Specifically, the controller 19 controls the small-flow regulating valve 14, large-flow regulating valve 15, pressure reducing valve 17, purge valve 18, bypass flow regulating valve 22, and others.

In the fuel cell system 1 configured as above, the pressure of the high-pressure fuel supplied from the fuel tank is reduced by the pressure reducing valve 17, the flow rate of this fuel is then regulated by the small-flow regulating valve 14 and the large-flow regulating valve 15 and supplied to the ejector 13, and thereafter the fuel is supplied via the ejector 13 to the FC stack 11 through the fuel supply passage 12. The bypass passage 21 and the bypass flow regulating valve 22 shown in FIG. 1 will be described later.

### <Bypass Passage>

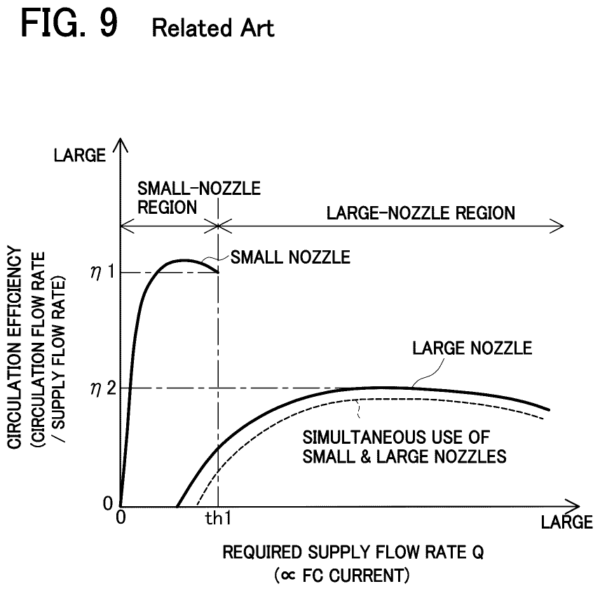

Conventionally, as shown in FIG. 9, in a small-nozzle region where the required supply flow rate Q, which is a supply flow rate of fuel required for the FC stack 11, gradually increases from zero until it reaches a first flow rate th1 that is the maximum flow rate during use of the small nozzle 32, the fuel is supplied to the FC stack 11 through the fuel supply passage 12 via the ejector 13 using the small nozzle 32. Then, when the required supply flow rate Q exceeds the first flow rate th1, the fuel is supplied to the FC stack 11 through the fuel supply passage 12 via the ejector 13 using the large nozzle 33. In this conventional manner, when the required supply flow rate Q exceeds the first flow rate th1, the nozzle used in the ejector 13 is switched from the small nozzle 32 to the large nozzle 33.

However, the circulation efficiency of the ejector 13 is significantly lower during use of the large nozzle 33 than during use of the small nozzle 32, as shown in FIG. 9. Therefore, when the nozzle used in the ejector 13 is switched from the small nozzle 32 to the large nozzle 33 immediately when the required supply flow rate Q becomes larger than the first flow rate th1, the circulation efficiency of the ejector 13 is largely lowered. Consequently, the circulation flow rate of off-gas to the ejector 13 is greatly decreased, resulting in a decreased flow rate of fuel to be supplied via the ejector 13 to the FC stack 11 through the fuel supply passage 12, and thus a required flow rate of fuel may not be supplied to the FC stack 11.

Herein, the circulation efficiency of the ejector 13 is the ratio of a flow rate of off-gas circulated to the ejector 13 with respect to a flow rate of fuel supplied to the FC stack 11, and is represented by the following expression.

$$( Circulation efficiency of ejector 13 ) = ( Circulation flow rate of off - gas to ejector 13 ) / ( Supply flow rate of fuel to FC stack 11 ) \qquad ( Expression 1 )$$

For example, when the small nozzle 32 and the large nozzle 33 are used simultaneously, a flow from the large nozzle 33 cancels out the negative pressure generated by the small nozzle 32, decreasing the circulation efficiency of the ejector 13 as indicated by a dotted line in FIG. 9.

In contrast, the fuel cell system 1 in the present embodiment includes the bypass passage 21 and the bypass flow regulating valve 22, as shown in FIG. 1. Herein, the bypass passage 21 is a passage provided between the pressure reducing valve 17 and the FC stack 11, separately from the fuel supply passage 12, to detour around the ejector 13, small-flow regulating valve 14, and large-flow regulating valve 15, and to supply fuel to the FC stack 11 not via, i.e., without passing through, the ejector 13. The bypass flow regulating valve 22 is a valve for regulating a flow rate of fuel in the bypass passage 21. The bypass flow regulating valve 22 is one example of a “bypass flow regulating unit” of the disclosure.

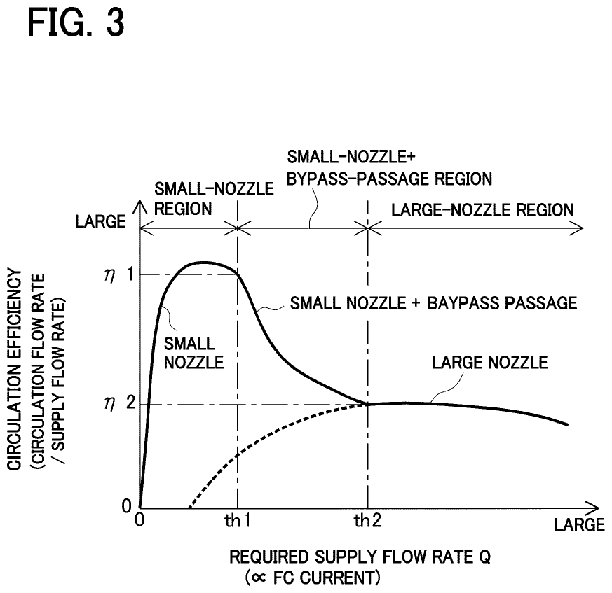

In the present embodiment, as shown in FIG. 3, when the required supply flow rate Q exceeds the first flow rate th1, the small nozzle 32 is continuously used and the bypass passage 21 is also used. Specifically, when the required supply flow rate Q increases from 0 and exceeds the small-nozzle region, in a “small-nozzle+bypass-passage region”, which is an intermediate region until the required supply flow rate Q reaches a second flow rate th2, the controller 19 continues to supply fuel to the FC stack 11 through the fuel supply passage 12 via the ejector 13 using the small nozzle 32 and also supply fuel to the FC stack 11 through the bypass passage 21. The small-nozzle region is one example of a “first supply region” of the disclosure. The “small-nozzle+bypass-passage region” is one example of a “second supply region” of the disclosure.

Herein, the second flow rate th2 is a supply flow rate of fuel supplied to the FC stack 11 when the circulation flow rate of the ejector 13 is at its maximum value η2 during supply of the fuel to the FC stack 11 through the fuel supply passage 12 via the ejector 13 using the large nozzle 33. Further, in FIG. 3, a value η1 is the value of the circulation efficiency of the ejector 13 when the required supply flow rate Q is the first flow rate th1.

In this way, the small nozzle 32 and the bypass passage 21 are used in the small-nozzle+bypass-passage region when the required supply flow rate Q exceeds the small-nozzle region. Thus, the circulation flow rate of the ejector 13 can be improved as compared with the related art in which the nozzle used in the ejector 13 is switched from the small nozzle 32 to the large nozzle 33 immediately when the required supply flow rate Q exceeds the small-nozzle region.

In the present embodiment, specifically, when the required supply flow rate Q increases beyond the small-nozzle region, the small nozzle 32 is continuously used as the nozzle used in the ejector 13 to supply fuel to the FC stack 11 and the bypass passage 21 is also used to supplementally supply fuel to the FC stack 11. Thus, since the small nozzle 32 providing a high circulation efficiency of the ejector 13 continues to be used, the circulation efficiency of the ejector 13 is suppressed from decreasing. This suppresses a decrease in the supply flow rate of off-gas to the ejector 13, making it possible to maintain the flow rate of fuel to be supplied to the FC stack 11 through the fuel supply passage 12 via the ejector 13, and also supplement the fuel to be supplied to the FC stack 11 through the bypass passage 21, so that a required flow rate of fuel can be stably supplied to the FC stack 11.

Note that the circulation flow rate ηX of the ejector 13 in the small-nozzle+bypass-passage region can be represented by the following mathematical expression:

$$η X = η1 \times th 1 / ( th 1 + thX ) \qquad ( Expression 2 )$$

wherein thX is a supply flow rate of fuel in the bypass passage 21.

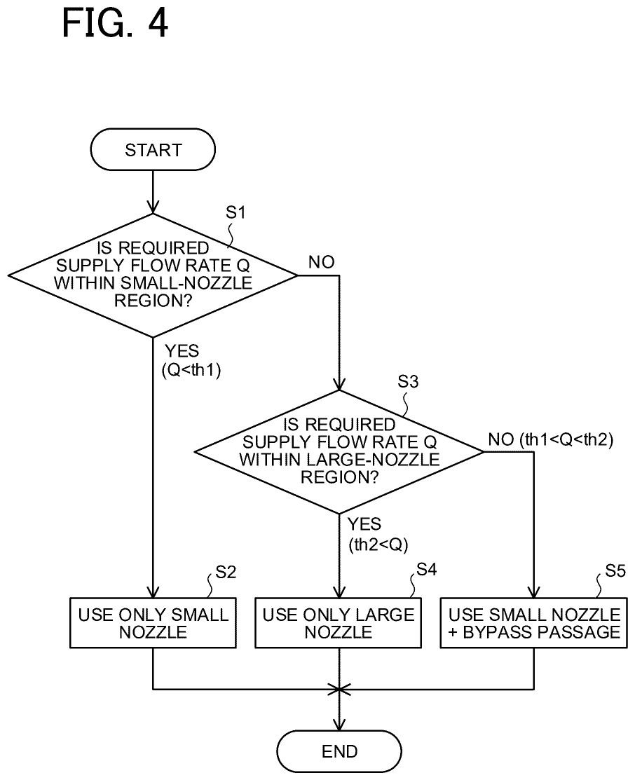

In the present embodiment, specifically, the controller 19 executes the control whose details are described in FIG. 4. As shown in FIG. 4, the controller 19 first determines whether or not the required supply flow rate Q is within the small-nozzle region (step S1).

When the required supply flow rate Q is within the small-nozzle region (step S1: YES), the controller 19 uses only the small nozzle 32 (step S2). In this way, in the small-nozzle region until the required supply flow rate Q reaches the first flow rate th1 which is the maximum flow rate during use of the small nozzle 32, the controller 19 supplies the fuel to the FC stack 11 through the fuel supply passage 12 via the ejector 13 using the small nozzle 32 while regulating the flow rate of fuel to be supplied to the small nozzle 32 by the small-flow regulating valve 14.

On the other hand, when the required supply flow rate Q is not within the small-nozzle region (step S1: NO), the controller 19 determines whether or not the required supply flow rate Q is within the large-nozzle region (step S3). The large-nozzle region is one example of a “third supply region” of the disclosure.

When the required supply flow rate Q is within the large-nozzle region (step S3: YES), the controller 19 uses only the large nozzle 33 (step S4). In this way, in the large-nozzle region where the required supply flow rate Q exceeds the small-nozzle+bypass-passage region, the controller 19 supplies fuel to the FC stack 11 through the fuel supply passage 12 via the ejector 13 using the large nozzle 33 while regulating the flow rate of the fuel supplied to the large nozzle 33 by the large-flow regulating valve 15.

On the other hand, when the required supply flow rate Q is not within the large-nozzle region (step S3: NO), that is, when the required supply flow rate Q is within the small-nozzle+bypass-passage region where it is larger than the first flow rate th1 but smaller than the second flow rate th2, the controller 19 uses the small nozzle 32 and the bypass passage 21 (step S5). In this way, when the required supply flow rate Q is within the small-nozzle+bypass-passage region, the controller 19 supplies fuel to the FC stack 11 through the fuel supply passage 12 via the ejector 13 using the small nozzle 32 while regulating the flow rate of fuel to be supplied to the small nozzle 32 by the small-flow regulating valve 14 and additionally supplies fuel to the FC stack 11 through the bypass passage 21 without passing through the ejector 13 while regulating the flow rate of fuel in the bypass passage 21 by the bypass flow regulating valve 22.

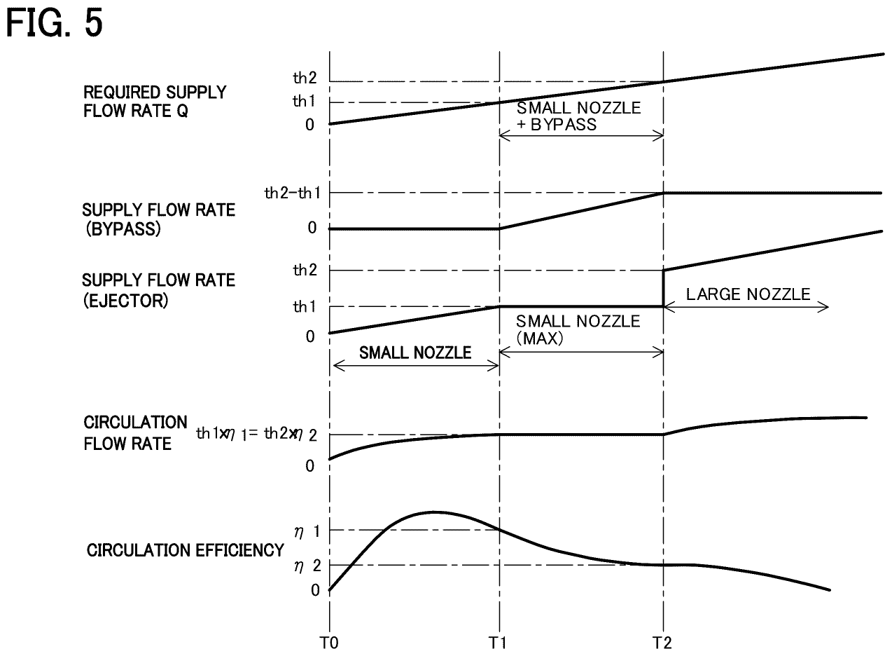

By executing the control shown in FIG. 4, for example, the control shown in a time chart of FIG. 5 is performed as one example. As shown in FIG. 5, in the region where the required supply flow rate Q increases from 0 (time T0) until it reaches the first flow rate th1 (time T1), which is considered as the small-nozzle region, only the small nozzle 32 is used.

Subsequently, in the region where the required supply flow rate Q increases from the first flow rate th1 until it reaches the second flow rate th2 (time T2), which is considered as the small-nozzle+bypass-passage region, both the small nozzle 32 and the bypass passage 21 are used.

Furthermore, in the region after the required supply flow rate Q increases above the second flow rate th2 (subsequent to time T2), which is considered as the large-nozzle region, the large nozzle 33 is used.

### <Operations and Effects of Embodiment>

The fuel cell system 1 in the embodiment, as described above, includes the bypass passage 21 for supplying fuel to the FC stack 11 without passing through the ejector 13 and the bypass flow regulating valve 22 for regulating the flow rate of fuel in the bypass passage 21.

With this configuration, if the flow rate of fuel supplied to the FC stack 11 through the fuel supply passage 12 via the ejector 13 is insufficient for a required flow rate, fuel is also supplied to the FC stack 11 through the bypass passage 21, not via the ejector 13. This allows the required flow rate of fuel to be stably supplied to the FC stack 11. Thus, the controllability of the FC stack 11 can be improved.

In the small-nozzle region until the required supply flow rate Q reaches the first flow rate th1, the controller 19 supply fuel to the FC stack 11 through the fuel supply passage 12 via the ejector 13 using the small nozzle 32.

Further, when the required supply flow rate Q exceeds the small-nozzle region, the controller 19 supplies fuel to the FC stack 11 through the fuel supply passage 12 via the ejector 13 using the small nozzle 32 and also supplies fuel to the FC stack 11 through the bypass passage 21 in the small-nozzle+bypass-passage region, which is the intermediate region until the required supply flow rate Q reaches the second flow rate th2.

In the large-nozzle region where the required supply flow rate Q exceeds the small-nozzle+bypass-passage region, the controller 19 supplies fuel to the FC stack 11 through the fuel supply passage 12 via the ejector 13 using the large nozzle 33.

As described above, under a situation where fuel is being supplied to the FC stack 11 using the small nozzle 32, in the small-nozzle+bypass-passage region from when the required supply flow rate of fuel exceeds the small-nozzle region until the required supply flow rate reaches the second flow rate th2, the fuel is supplied to the FC stack 11 through the bypass passage 21 while supply of the fuel to the FC stack 11 using small nozzle 32 is continued. In this way, the small nozzle 32 providing a higher circulation efficiency of the ejector 13 than the large nozzle 33 is continuously used.

This configuration can improve the circulation efficiency of the ejector 13 as compared with the configuration that supplies fuel to the FC stack 11 using the large nozzle 33 by switching from the small nozzle 32 to the large nozzle 33 immediately when the required supply flow rate Q exceeds the small-nozzle region. Therefore, the fuel is supplied to the FC stack 11 through the fuel supply passage 12 via the ejector 13 while ensuring the circulation flow rate of off-gas to the ejector 13 and also the fuel is supplied to the FC stack 11 through the bypass passage 21. This can stably supply a required flow rate of fuel to the FC stack 11 more reliably.

Further, the small nozzle 32 is used in the small-nozzle region, the small nozzle 32 and the bypass passage 21 are used in the small-nozzle+bypass-passage region, and the large nozzle 33 is used in the large-nozzle region. This configuration can stably supply a required flow rate of fuel to the FC stack 11 in all the regions of required supply flow rates of fuel for the FC stack 11.

The small-nozzle region may be a region until the required supply flow rate nearly reaches the first flow rate th1. The small-nozzle+bypass-passage region may be a region until the required supply flow rate nearly reaches the second flow rate th2.

### Second Embodiment

Next, a second embodiment will be described with a focus on differences from the first embodiment.

In this embodiment, when switching the nozzle used in the ejector 13 from the small nozzle 32 to the large nozzle 33, both the small nozzle 32 and the large nozzle 33 are used together for a predetermined time Δt. Herein, the predetermined time Δt is the time determined in consideration of the response of the small nozzle 32 from injection execution (use) to stop of injection (non-use) and the response of the large nozzle 33 from stop of injection (non-use) to start of injection execution (use).

This configuration can compensate a shortage of flow rate of fuel at the initial stage when the nozzle used in the ejector 13 is switched from the small nozzle 32 to the large nozzle 33, and thus the circulation efficiency of the ejector 13 can be improved.

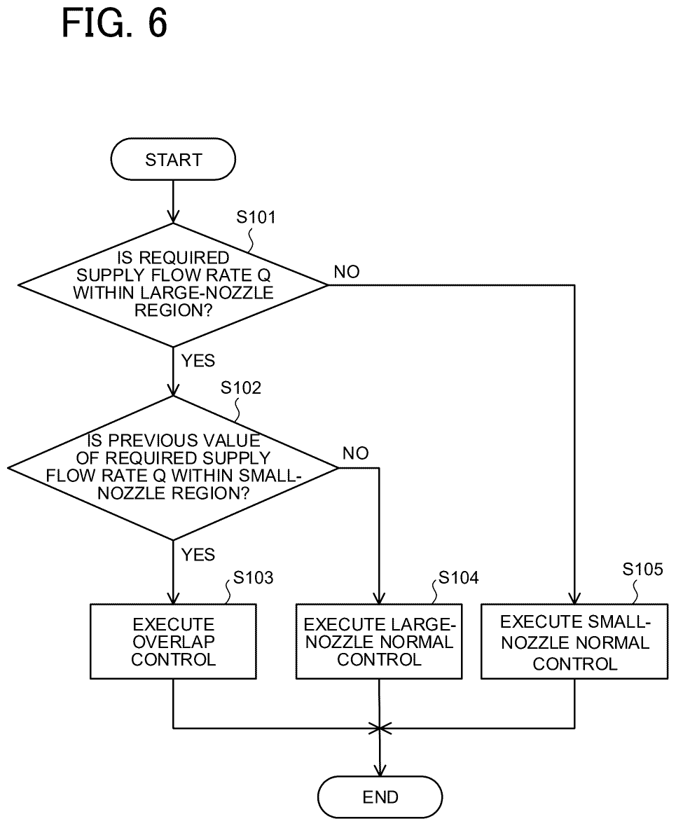

Specifically, the controller 19 performs the control whose details are described in FIG. 6. As shown in FIG. 6, the controller 19 first determines whether or not the required supply flow rate Q is within the large-nozzle region (step S101).

When the required supply flow rate Q is within the large-nozzle region (step S101: YES), the controller 19 determines whether or not a previous value of the required supply flow rate Q is within the small-nozzle region (step S102). The “previous value of a required supply flow rate Q” is a value of the required supply flow rate Q determined when the control shown in FIG. 6 is performed the last time.

When the previous value of the required supply flow rate Q is within the small-nozzle region (step S102: YES), the controller 19 executes the overlap control (step S103). Herein, the “overlap control” uses both the small nozzle 32 and the large nozzle 33.

On the other hand, when the previous value of the required supply flow rate Q is not within the small-nozzle region (step S102: NO), the controller 19 executes the large-nozzle normal control (step S104). Herein, the “large-nozzle normal control” uses only the large nozzle 33.

When the required supply flow rate Q is not within the large-nozzle region in step S101 (step S101: NO), the controller 19 executes the small-nozzle normal control (step S104). Herein, the “small-nozzle normal control” uses only the small nozzle 32.

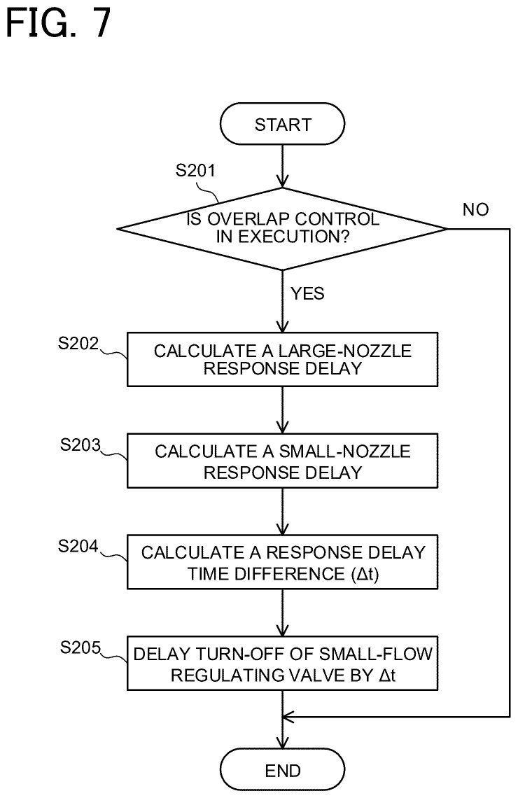

Further, the overlap control is performed as described in FIG. 7. As shown in FIG. 7, the controller 19 determines whether or not the overlap control is in execution (step S201).

When the overlap control is being executed (step S201: YES), the controller 19 calculates a large-nozzle response delay, which is a response delay from injection stop (non-use) to start of injection execution (use) of the large nozzle 33 (step S202), calculates a small-nozzle response delay, which is a response delay from injection execution (use) to injection stop (non-use) of the small nozzle 32 (step S203), and calculates a predetermined time Δt corresponding to a difference in response delay time between the large-nozzle response delay and the small-nozzle response delay (step S204). The controller 19 then delays the timing of turning off the small-flow regulating valve 14 by the predetermined time Δt (step S205). Thus, when switching the nozzle used in the ejector 13 from the small nozzle 32 to the large nozzle 33, both the small nozzle 32 and the large nozzle 33 are used for the predetermined time Δt.

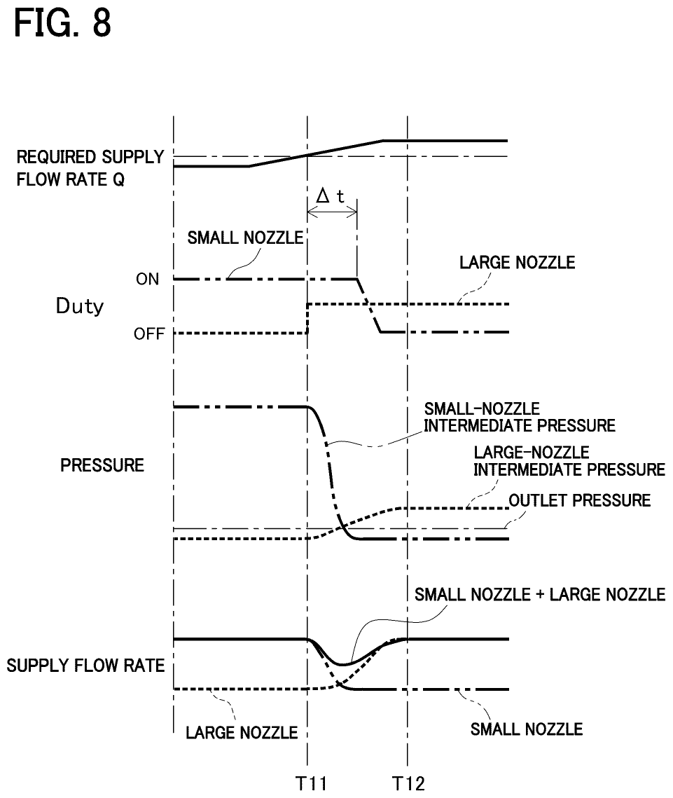

By executing the controls shown in FIG. 6 and FIG. 7, for example, the control shown in a time chart of FIG. 8 is performed as one example. As shown in FIG. 8, when the required supply flow rate Q (an FC required current) reaches a threshold and the nozzle used in the ejector 13 is switched from the small nozzle 32 to the large nozzle 33 (time T11), thereafter, the small nozzle 32 is continuously used as indicated by a broken line in the figure, and both the small nozzle 32 and the large nozzle 33 are used for the predetermined time Δt. This makes it possible to ensure a supply flow rate of fuel even in a period of time from T11 to T12, in which the flow rate would be insufficient conventionally. In FIG. 8, the “small-nozzle intermediate pressure” is the pressure at a position between the small-flow regulating valve 14 and the small nozzle 32, the large-nozzle intermediate pressure” is the pressure at a position between the large-flow regulating valve 15 and the large nozzle 33, and the “outlet pressure” is the pressure at an outlet of the ejector 13.

The foregoing embodiments are mere examples and give no limitation to the present disclosure. The present disclosure may be embodied in other specific forms without departing from the essential characteristics thereof.

### REFERENCE SIGNS LIST

1 Fuel cell system
11 FC stack
12 Fuel supply passage
13 Ejector
16 Circulation passage
19 Controller
21 Bypass passage
22 Bypass flow regulating valve
32 Small nozzle
33 Large nozzle
Q Required supply flow rate
th1 First flow rate
th2 Second flow rate
Δt Predetermined time

1. A fuel cell system including:
a fuel cell;
a fuel supply passage for supplying fuel to the fuel cell;
an ejector provided in the fuel supply passage; and
a circulation passage for circulating the fuel that is unused in and discharged from the fuel cell to the ejector,
the fuel cell system being configured to supply the fuel to the fuel cell through the fuel supply passage via the ejector,
wherein the fuel cell system comprises:
a bypass passage for supplying the fuel to the fuel cell without passing through the ejector; and
a bypass flow regulating unit for regulating a flow rate of the fuel in the bypass passage.

2. The fuel cell system according to claim 1,
wherein the ejector includes, as a nozzle for injecting the fuel,
a first nozzle; and
a second nozzle that can inject the fuel with a larger flow rate than the first nozzle,
wherein in a first supply region until a required supply flow rate of the fuel for the fuel cell reaches or nearly reaches a first flow rate that is a maximum flow rate during use of the first nozzle, the fuel is supplied to the fuel cell using the first nozzle,
in a second supply region from when the required supply flow rate of the fuel for the fuel cell exceeds the first supply region until the required supply flow rate reaches or nearly reaches a second flow rate, which is a maximum flow rate at which a circulation efficiency of the ejector becomes a maximum value during use of the second nozzle, the fuel is supplied to the fuel cell using the first nozzle and also the fuel is supplied to the fuel cell through the bypass passage, and
in a third supply region where the required supply flow rate of the fuel for the fuel cell exceeds the second supply region, the fuel is supplied to the fuel cell using the second nozzle.

3. A fuel cell system including:
a fuel cell;
a fuel supply passage for supplying fuel to the fuel cell;
an ejector provided in the fuel supply passage; and
a circulation passage for circulating the fuel that is unused in and discharged from the fuel cell to the ejector,
the fuel cell system being configured to supply the fuel to the fuel cell through the fuel supply passage via the ejector,
wherein the ejector includes, as a nozzle for injecting the fuel,
a first nozzle; and
a second nozzle that can inject the fuel with a larger flow rate than the first nozzle, and
when switching the nozzle used from the first nozzle to the second nozzle, both the first and second nozzles are used for a predetermined time.
